(19) United States
(12) Patent Application Publication
(10) Pub. No.: US 2012/0316950 A1
(43) Pub. Date: Dec. 13, 2012

(54) SYSTEM AND METHOD FOR AUGMENTATION OF RETAIL POS DATA STREAMS WITH TRANSACTION INFORMATION

(76) Inventors: Jeffrey LaPorte, Vancouver (CA); Nigel Malkin, Vancouver (CA)

(21) Appl. No.: 13/492,568

(22) Filed: Jun. 8, 2012

Related U.S. Application Data
(60) Provisional application No. 61/495,894, filed on Jun. 10, 2011.

(51) Int. Cl. G06Q 20/20; G06Q 30/02

(52) U.S. Cl. 705/14.33; 705/24; 705/14.27

(57) ABSTRACT

Systems and methods for the capture of retail transaction data from a print data stream after it has been processed by a POS system. The data capture may take place before the data has been transmitted to a POS printer. The captured transaction data may be analyzed and encoded in a transaction-identifying, optically scannable image such as a QR code or other barcode. One or more NFC commands may transmit the captured transaction data via a NFC-transmitting device to a mobile device such as mobile phone, smart phone, mobile computer, tablet, or other device.

### CLAIM OF PRIORITY

This patent application claims the benefit of priority to U.S. Provisional Application No. 61/495,894, filed Jun. 10, 2011, which is incorporated by reference herein in its entirety.

### TECHNICAL FIELD

This disclosure relates generally to the field of retail loyalty systems, and more specifically, but not by way of limitation, to the field of mobile-enabled retail loyalty systems connected to point-of-sale systems.

### BACKGROUND

A deeply fragmented POS ecosystem, legacy POS infrastructure, and sometimes uncooperative POS vendors, have created a worldwide payments ecosystem filled with seemingly insurmountable scalability challenges for any industry that wishes to broadly integrate new technologies across multiple POS platforms.

Industries facing POS scalability challenges for their innovations include: mobile customer loyalty, mobile payments, social media (including mobile social “check-ins”), mobile coupons, mobile stored value (virtual gift cards), and mobile personal finance (managing bills and receipts electronically).

A steady stream of new POS-integration-dependent innovations are announced every year that capture the imaginations of the industries they touch, but wide-scale deployment is never achieved because there are over 300 different POS platforms in circulation today. Currently, any new POS-dependent innovation requires a custom integration with each POS platform to support the merchants using that platform. Few companies can afford the human and financial resources required to integrate across enough POS platforms to achieve wide scale reach. As a result, innovators tend to focus on a few key POS systems. This often gives rise to copycats and clones that focus on competing POS platforms. Further fragmentation is the result. Regardless of the fact that common standards and inter-operability across POS platforms are in the best interest of consumers and commerce, these ideals have been impossible to date due to the fragmented structure of the POS marketplace and the lack of a technical solution that can universally resolve this fragmentation.

### OVERVIEW

A system is disclosed that provides an improvement over the current state of the art because it provides enhanced compatibility with the majority of POS platforms and POS infrastructure in circulation today. The cross-POS platform interoperability enables multiple industries to deploy and scale their innovations quickly and inexpensively. Further, some embodiments may create a common standard for POS integrations that will accelerate POS-integration-dependent innovations across multiple industries including, but not limited to: mobile customer loyalty, mobile payments, social media (including mobile social “check-ins”), mobile coupons, mobile stored value (gift cards), and mobile personal finance (managing bills and receipts electronically).

A system is disclosed herein that captures retail transaction data from a print data stream after it has been processed by a POS system. In some embodiments, the data capture takes place before the data has been transmitted to the POS printer. Various embodiments augment this data with additional data including a) one or more print commands that cause the printer to print a transaction-identifying, optically scannable image such as a QR code or some other barcode, and/or both) one or more NFC commands that transmit transaction data via a NFC-transmitting device to the consumer's mobile device such as mobile phone, mobile computer, tablet, etc.

Some embodiments are directed to applications in the customer loyalty industry. Other embodiments are adapted to in the following industries/applications including, but not limited to:

Mobile Payments:

The transactions enabled by several embodiments of the invention via scanning of printed 2D barcodes or tapping of an NFC pad with a mobile device may be used to facilitate secure mobile payments, through processing of a payment transaction using a credit card, mobile wallet, or other payment method associated with a user's mobile device. This is important to the mobile payments industry because the single largest challenge facing the industry is cross-POS scalability.

Social Media (Including Mobile Social “Check-Ins”):

The 2D barcode-based and/or NFC-based transactions enabled by several embodiments of the invention can be used to facilitate secure social “check-ins” through users' mobile devices. As used herein, “check-in” refers generally to a system/method of registering a person's physical location through a communication between a device (e.g., a mobile device carried by the person) and a system that is configured to communicate with the device and electronically detect/record the person as having been present at the physical location. This is important to the social media industry because the industry aspires to create an advertising model whereby it charges advertisers when users “check-in” to an advertiser's physical location. However, the current state of the art has users “check-in” via location based services (LBS) or QR code-based “check-ins” that are not associated with a particular transaction, or a combination of both LBS and QR code “check-ins.” These forms of “check-ins” are highly prone to user fraud on multiple fronts and pose liabilities to advertisers and ad networks. They do not prove the consumer who “checked-in” actually spent money, nor how much. The social media industry needs a solution that enables secure, transaction-specific “check-ins.” Some embodiments thus separate consumers who make purchases from those who do not and thereby reduce fraud and abuse that exist in the current “check-in” systems. Furthermore, embodiments may provide an ability to tie “check-in” data with purchase data so that advertising model can be additional tailored based on criteria such as types of products/services purchased and amounts spent.

Mobile Coupons:

The 2D barcode-based and/or NFC-based transactions enabled by embodiments can be used to facilitate secure, track-able, one-time-use mobile coupons through users' mobile devices that are connected to specific and identifiable users. In some embodiments, a consumer could pre-load a digital coupon into their account with a merchant via a print or online advertisement for future use. Some embodiments can be configured to enable secure redemptions in-store. This is important to the coupon industry, and those industries that publish coupons, because the industries aspires to create a mobile/digital model that provides the same level of security as traditional paper-based coupons. Paper coupons provide a physical record of a one-time-use coupon that cannot easily be duplicated. Digital coupons have proven challenging for advertisers because they are easily duplicated (by consumers and employees) and it has been difficult to create a secure digital equivalent of the one-time-use nature of a physical paper coupon. The coupon industry, and the industries that distribute coupons, need a solution that enables secure, track-able, one-time-use mobile coupons.

Mobile Stored Value (Gift Cards):

The 2D barcode-based and/or NFC-based transactions enabled by some embodiments of the invention can be used to facilitate secure mobile stored value transactions on users' mobile devices. Earned loyalty reward assumes the form of stored value credits via the invention. In addition to earning via customer loyalty flows, stored value credits can be purchased or gifted just like traditional physical stored value cards. This is important to the mobile stored value (gift card) industry because the industry needs to evolve to offer card-less mobile solutions that are as secure as the current physical card-based offerings. The mobile stored value (gift card) industry needs a solution that enables secure, card-less transactions on consumers' mobile devices.

Mobile Personal Finance (Managing Bills and Receipts Electronically):

The 2D barcode-based and/or NFC-based transactions enabled by the invention can be used to facilitate the collection of secure electronic purchase records via users' mobile devices. This is important to the mobile personal finance industry because the industry needs find ways to make it simpler for consumers to electronically gather and record transaction data. Further, the industry has a particular need for NFC-based solutions that enable paper-less gathering of personal finance information because of the ecological benefits these solutions will facilitate. The mobile personal finance industry needs a solution that enables secure, card-less collection of bills and receipts via consumers' mobile devices.

In addition to the variety of practical applications described above, embodiments of the invention also include the following aspects:

1. Adding QR codes to receipts without needing POS integration

2. Security of loyalty redemptions (SecureID-type verification flow)

3. NFC loyalty transactions outside POS system

4. NFC payments outside POS system

Loyalty program fundamentals hold true, but consumers have developed “loyalty card fatigue” and don't want to carry a loyalty card for every merchant (today's average is 3.2 active loyalty accounts per consumer). As a result, merchants have difficulty attracting and maintaining loyalty program memberships, and therefore do not achieve the incremental revenue benefits loyalty programs can produce.

This disclosure also describes a system that helps overcome this challenge by offering merchants the ability to have machine-readable transaction-identifiers such as, but not limited to, 2D barcodes printed on bills and receipts in order to enable their customers to participate in loyalty programs (e.g., earn or accumulate stored value) using the barcode scanning capabilities of their Internet-connected wireless mobile devices.

While most bill and receipt printers installed in the marketplace are capable of printing graphical identifiers, it can be difficult and time consuming to update the Point of Sale (POS) systems used by many merchants, which send print data stream commands to these bill and receipt printers. Further some POS vendors and service providers do not offer this service to their merchant customers at all.

In scenarios whereby wireless device-based loyalty program end-users who have a redeemable loyalty reward or stored value in their loyalty account wish to complete a reward or stored value redemption, merchants need a method to verify the validity of the redemption request. They need to verify the user actually has enough redeemable credits to redeem a reward, and they need to verify that the user is not presenting the cashier or server with a fraudulent representation of this eligibility on their mobile device.

The advent of Near Field Communication (NFC) technologies will create an opportunity among merchants to offer NFC payment and loyalty solutions. Given that loyalty programs may be operated independently of payment card data, and the additional layers of complexity surrounding mobile payments, NFC loyalty solutions may see traction in the marketplace first. For those consumers with NFC-enabled wireless mobile phones, merchants may wish to enable NFC loyalty solutions. Again, it can be difficult, costly, and time consuming to integrate such solutions with the many Point of Sale (POS) systems in use in the marketplace. Merchants may want to begin operating NFC-based loyalty programs in advance of such solutions becoming commercially available from their POS providers, and in advance of accepting NFC payments.

For consumers, the process of opening each new loyalty account can be inconvenient. Typically, it requires filling out paper-based, or online forms, and providing all of their profile data to yet another company. Consumers have become weary of filling out so many forms with the same data over and over again. In cases where a consumer is willing to share this data with a merchant, but is disinclined to invest the time to complete the task of filling out another form, consumers would be more inclined to open a loyalty account if they had the ability to simply opt-in to the merchant's email, loyalty, affinity, or rewards program by sharing of a limited portion of their profile data automatically.

### BRIEF DESCRIPTION OF THE DRAWINGS

FIG. 1 is a high-level block diagram of a computing environment according to an embodiment of the present invention.

FIG. 2 is a high-level block diagram illustrating a functional view of a typical computer system for use as print stream augmentation device 104 illustrated in the environment of FIG. 1 according to an embodiment of the present invention.

FIG. 3 is a high-level block diagram illustrating modules within the print stream augmentation device 104 according to an embodiment.

FIG. 4 and FIG. 5 are flow charts illustrating the operation of the print stream augmentation device according to an embodiment.

FIG. 6 is a diagram of a printed receipt 601 and redemption verification slip 602 according to an embodiment of the present invention.

FIG. 7 is a block diagram of a print stream augmentation device 104 attached to a merchant PC 702 for the purpose of downloading the device's configuration information.

FIG. 8 is a high-level block diagram of a computing environment according to an embodiment of the present invention.

FIG. 9 is a flow chart illustrating the operation of the print stream augmentation device according to an embodiment supporting a secure location check-in process.

The figures depict various embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### I. OVERVIEW

The most common types of Point of Sale (POS) data streams are print data streams, however POS data streams directed to retail displays are also common. Some POS data stream languages are capable of encoding data for use in controlling both printer peripherals and display peripherals. For example, the Epson® ESC/POS® printer language is in fact a language for controlling both printer and display peripherals. Typically, the POS data stream in question need only carry useful information about a transaction or item or tendered amount to a point-of-sale peripheral. With this requirement satisfied, some embodiments of the invention can be used to extract the retail information in the data streams in whole or in part, and/or inject additional data for use at the retail peripheral. In this disclosure the POS data streams will be described as printer data streams, but it should be understood to include POS data streams directed to retail displays as well.

Several embodiments of the invention can be implemented in numerous ways, including as a process, an apparatus, a system, a computer readable medium such as a computer readable storage medium or a computer network wherein program instructions are sent over optical or communication links. In this specification, these implementations, or any other form that the invention may take, may be referred to as systems or techniques. A component such as a processor or a memory described as being configured to perform a task may encompass both a general component that is temporarily configured to perform the task at a given time, or a specific component that is manufactured to perform the task. In general, the order of the steps of disclosed processes may be altered within the scope of the invention.

The following disclosure provides a brief and general description of a suitable computing environment in which various embodiments of the system may be implemented. Although not required, embodiments will be described in the general context of computer-executable instructions, such as program applications, modules, objects or macros being executed by a computer. Those skilled in the relevant art will appreciate that the invention can be practiced with other computer configurations, including hand-held devices, multiprocessor systems, microprocessor-based or programmable consumer electronics, personal computers (“PCs”), network PCs, mini-computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

A computer system may be used as a server including one or more processing units, system memories, and system buses that couple various system components including system memory to a processing unit. Computers will at times be referred to in the singular herein, but this is not intended to limit the application to a single computing system since in typical embodiments, there will be more than one computing system or other device involved. Other computer systems may be employed, such as conventional and personal computers, where the size or scale of the system allows. The processing unit may be any logic processing unit, such as one or more central processing units (“CPUs”), digital signal processors (“DSPs”), application-specific integrated circuits (“ASICs”), etc. Unless described otherwise, the construction and operation of the various components are of conventional design. As a result, such components need not be described in further detail herein, as they will be understood by those skilled in the relevant art.

A computer system includes a bus, and can employ any known bus structures or architectures, including a memory bus with memory controller, a peripheral bus, and a local bus. The computer system memory may include read-only memory (“ROM”) and random access memory (“RAM”). A basic input/output system (“BIOS”), which can form part of the ROM, contains basic routines that help transfer information between elements within the computing system, such as during startup.

The computer system also includes non-volatile memory. The non-volatile memory may take a variety of forms, for example a hard disk drive for reading from and writing to a hard disk, and an optical disk drive and a magnetic disk drive for reading from and writing to removable optical disks and magnetic disks, respectively. The optical disk can be a CD-ROM, while the magnetic disk can be a magnetic floppy disk or diskette. The hard disk drive, optical disk drive and magnetic disk drive communicate with the processing unit via the system bus. The hard disk drive, optical disk drive and magnetic disk drive may include appropriate interfaces or controllers coupled between such drives and the system bus, as is known by those skilled in the relevant art. The drives, and their associated computer-readable media, provide non-volatile storage of computer readable instructions, data structures, program modules and other data for the computing system. Although a computing system may employ hard disks, optical disks and/or magnetic disks, those skilled in the relevant art will appreciate that other types of non-volatile computer-readable media that can store data accessible by a computer system may be employed, such a magnetic cassettes, flash memory cards, digital video disks (“DVD”), Bernoulli cartridges, RAMs, ROMs, smart cards, etc.

Various program modules or application programs and/or data can be stored in the computer memory. For example, the system memory may store an operating system, end user application interfaces, server applications, and one or more application program interfaces (“APIs”).

The computer system memory also includes one or more networking applications, for example a Web server application and/or Web client or browser application for permitting the computer to exchange data with sources via the Internet, corporate Intranets, or other networks as described below, as well as with other server applications on server computers such as those further discussed below. The networking application, in an embodiment, is markup language based, such as hypertext markup language (“HTML”), extensible markup language (“XML”) or wireless markup language (“WML”), and operates with markup languages that use syntactically delimited characters added to the data of a document to represent the structure of the document. A number of Web server applications and Web client or browser applications are commercially available, such those available from Mozilla and Microsoft. The operating system and various applications/modules and/or data can be stored on the hard disk of the hard disk drive, the optical disk of the optical disk drive and/or the magnetic disk of the magnetic disk drive.

A computer system can operate in a networked environment using logical connections to one or more client computers and/or one or more database systems, such as one or more remote computers or networks. A computer may be logically connected to one or more client computers and/or database systems under any known method of permitting computers to communicate, for example through a network such as a local area network (“LAN”) and/or a wide area network (“WAN”) including, for example, the Internet. Such networking environments are well known including wired and wireless enterprise-wide computer networks, intranets, extranets, and the Internet. Other embodiments include other types of communication networks such as telecommunications networks, cellular networks, paging networks, and other mobile networks. The information sent or received via the communications channel may, or may not be encrypted. When used in a LAN networking environment, a computer is connected to the LAN through an adapter or network interface card (communicatively linked to the system bus). When used in a WAN networking environment, a computer may include an interface and modem or other device, such as a network interface card, for establishing communications over the WAN/Internet.

In a networked environment, program modules, application programs, or data, or portions thereof, can be stored in a computer for provision to the networked computers. In an embodiment, the computer is communicatively linked through a network with TCP/IP middle layer network protocols; however, other similar network protocol layers are used in other embodiments, such as user datagram protocol (“UDP”). Those skilled in the relevant art will readily recognize that these network connections are only some examples of establishing communications links between computers, and other links may be used, including wireless links.

While in most instances a computer will operate automatically, where an end user application interface is provided, a user can enter commands and information into the computer through a user application interface including input devices, such as a keyboard, and a pointing device, such as a mouse. Other input devices can include a microphone, joystick, scanner, etc. These and other input devices are connected to the processing unit through the user application interface, such as a serial port interface that couples to the system bus, although other interfaces, such as a parallel port, a game port, or a wireless interface, or a universal serial bus (“USB”) can be used. A monitor or other display device is coupled to the bus via a video interface, such as a video adapter (not shown). The computer can include other output devices, such as speakers, printers, etc.

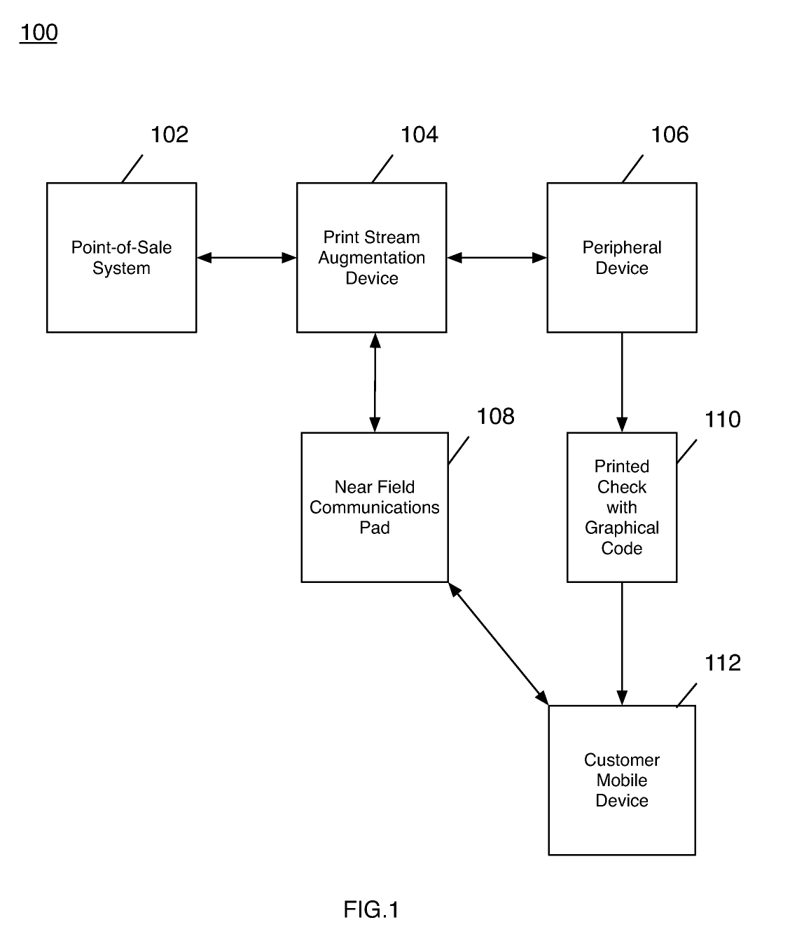

FIG. 1 is a high-level block diagram of a computing environment 100 according to an embodiment of the present invention. FIG. 1 illustrates a point-of-sale system 102, a retail data stream augmentation device 104, a point-of-sale peripheral 106, and a near field communications pad 108.

The point-of-sale system 102 in this embodiment represents a device that generates print data for delivery to a printer. As used herein, the point-of-sale system 102 may represent a component generating print data as a print data stream encoded using a print control language and transmitted via a communication port. The print data stream may utilize any print control language, such as Epson ESC/POS, JavaPOS, OPOS, StarLine, PostScript, PCL, or others. The point-of-sale communication port for example, can be an RS-232 port, USB port, Parallel port, Ethernet port, or a wireless port technology such as wireless USB, Bluetooth, Wireless Ethernet, GPRS, EDGE, HSPA, LTE, WiMax or other communication port technology.

In an embodiment, the point-of-sale system 102 comprises a computer system that is utilized by an end-user to initiate a transaction output process resulting in the output of a print data stream encoded in a print control language such as ESC/POS and transmitted by a communications port such as RS-232. The computer system, for example, can be a personal computer executing a point-of-sale application such as MICROS RES that allows the end-user to manage point-of-sale transactions and print checks or receipts associated with such transactions. In another embodiment, the point-of-sale system 102 can be a personal computer executing a web browser such as MICROSOFT INTERNET EXPLORER that allows the end-user to manage point-of-sale transactions using a cloud-based or web-based point-of-sale application such as VIVONET HALO that allows the end-user to manage point-of-sale transactions and to print checks or receipts associated with those transactions.

In an embodiment, the peripheral device 106 is a device that accepts print data and prints the text and/or images represented by the print data onto paper. In another embodiment, the peripheral device 106 may be a retail display. As used herein, the peripheral device 106 may represent a component accepting print data as a print data stream encoded using a print control language and received via a communication port. The print data stream may utilize any print control language, such as Epson ESC/POS, JavaPOS, OPOS, StarLine, PostScript, PCL, or others. The printer communication port for example, can be an RS-232 port, USB port, Parallel port, Ethernet port, or a wireless port technology such as wireless USB, Bluetooth, Wireless Ethernet, GPRS, EDGE, HSPA, LTE, WiMax or other communication port technology. The peripheral communication port may alternatively be a communication port technology implemented for use within a device in a point-to-point configuration or in a bus configuration, such as PCI, PCI Express, ISA, Extended ISA, PC-Card, I2C, SPI, Epson Universal Interface for TM printers, or other point-to-point or bus communication port technology.

The near field communications pad 108 is an optional device that may be configured to emulate a passive near field communications (NFC) target or NFC tag for reading by an NFC reader device. Mobile devices such as mobile phones with NFC reader capability are currently available and such capability is expected to proliferate and become very widely supported in most mobile phones and some other mobile devices.

In an embodiment, the near field communications pad 108 is connected to the print stream augmentation device 104 via a USB connection. The connection may alternatively be a different inter-device communication port technology or a communication port technology implemented for use within a device in a point-to-point configuration or in a bus configuration, such as PCI, PCI Express, ISA, Extended ISA, PC-Card, I2C, SPI, Epson Universal Interface for TM printers, or other point-to-point or bus communication port technology. In an embodiment, the near field communications pad 108 receives commands from the print stream augmentation device indicating the content of the NFC passive target to emulate. The command format for near field communications devices is commonly a proprietary USB device class, and support for communications with such devices is provided via a software developer's kit and application programming interfaces provided by the near NFC device manufacturer.

In an embodiment, the peripheral device 106 is an Epson receipt printer accepting print data as a print data stream encoded using the ESC/POS print control language received via an RS-232 port.

In an embodiment, the print stream augmentation device 104 is a device that receives print stream data via a first communications port and extracts data from the print stream data, generates additional data, encodes the additional data using a print control language, inserts the encoded additional data at a configured point in the print stream data, and transmits the modified print stream data via a second communications port (e.g., to the peripheral device 106). The print stream augmentation device may optionally transmit commands via a third communications port to the near field communications pad 108 indicating the content of a passive NFC tag to emulate. The print data stream may utilize any print control language, such as Epson ESC/POS, JavaPOS, OPOS, StarLine, PostScript, PCL, or others. The first communication port for example, can be an RS-232 port, USB port, Parallel port, Ethernet port, Firewire port, or a wireless port technology such as wireless USB, Bluetooth, Wireless Ethernet, GPRS, EDGE, HSPA, LTE, WiMax or other communication port technology. The first communication port may alternatively be a communication port technology implemented for use within a device in a point-to-point configuration or in a bus configuration, such as PCI, PCI Express, ISA, Extended ISA, PC-Card, I2C, SPI, Epson Universal Interface for TM printers, or other point-to-point or bus communication port technology. Similarly, the second communications port may utilize said communication port technologies or other communication port technologies. The first and second communications ports may utilize different technologies from one another. For example, the first communications port may utilize Star Micronics print language over RS-232, and the second communications port may utilize Epson ESC/POS over USB.

Various embodiments of the print stream augmentation device 104 may be adapted for use as a part of a customer loyalty system that integrates point-of-system devices with computing systems/devices that implement a customer loyalty program, such as that described in U.S. Patent Publication No. 2011/0307318m, published on Dec. 15, 2011, and entitled “Mobile Retail Loyalty Network.”

### II. SYSTEM ARCHITECTURE

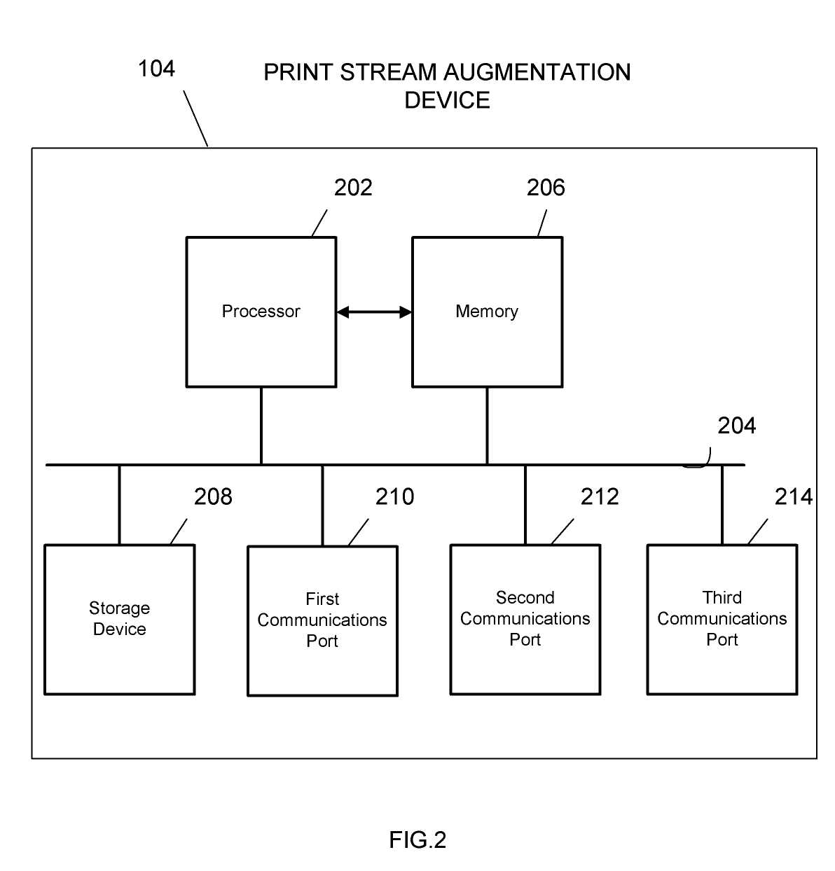

FIG. 2 is a high-level block diagram illustrating a functional view of the components of the print stream augmentation device 104 according to an embodiment of the present invention. Illustrated as part of the computing system are at least one processor 202 coupled to a bus 204. Also coupled to the bus 204 are memory 206, a storage device 208, a first communications port 210, a second communications port 212, and a third communications port 214.

The processor 202 may be any general-purpose processor such as an INTEL x86, ARM, Atmel AVR, or POWERPC compatible-CPU. The storage device 208 is, in an embodiment, a solid-state memory device but can also be any other device capable of storing data, such as a hard disk drive, writeable compact disk (CD) or DVD, or a solid-state memory device. The memory 206 may be, for example, firmware, read-only memory (ROM), non-volatile random access memory (NVRAM), and/or RAM. The storage device 208 and/or the memory 206 may hold instructions and data used by the processor 202.

As is known in the art, the computer system 200 is adapted to execute computer program modules. As used herein, the term “module” refers to computer program logic and/or data for providing the specified functionality. A module can be implemented in hardware, firmware, and/or software. In an embodiment, the modules are stored on the storage device 208, loaded into the memory 206, and executed by the processor 202.

The types of computer systems 200 utilized by the print stream augmentation device of FIG. 1 can vary depending upon the embodiment and the processing power utilized by the entity. Thus, for example, the print stream augmentation device computer system can be a microcontroller-based embedded computer system, a single board computer or a standard personal computer system. The first communications port 210, the second communications port 212, and the third communications port 214 correspond, respectively, to the first, second, and third communications ports of the print stream augmentation device 104 previously described above. In an embodiment, the print stream augmentation device 104 is additionally adapted to communicate either with a remote server or another computing device to obtain data used in the data augmentation process and/or send transaction data it extracts from the print stream. For example, the print stream augmentation device 104 may obtain from a remote server information related to how to process incoming data related to a particular transaction or a particular type of transactions.

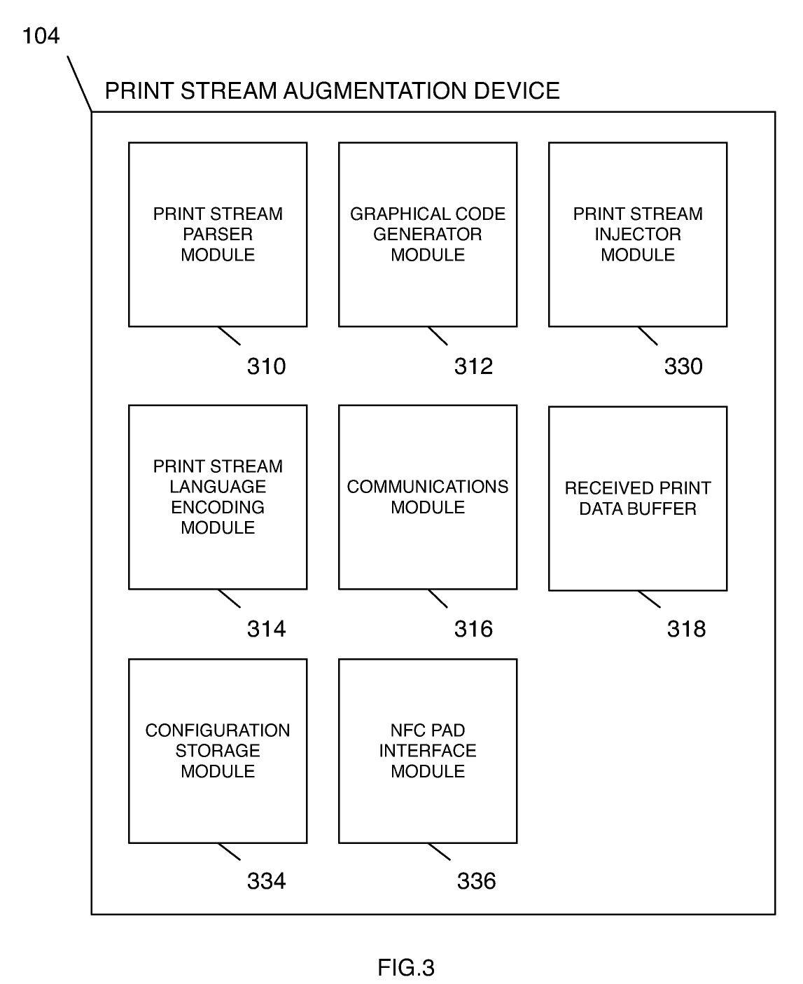

FIG. 3 is a high-level block diagram illustrating modules within the print stream augmentation device 104 according to an embodiment. Those of skill in the art will recognize that other embodiments can have different and/or other modules than the ones described here, and that the functionalities can be distributed among the modules in a different manner. These modules described below generally refer to logic embodied in hardware and/or firmware, and/or to a collection of software instructions, possibly having entry and exit points, written in a programming language, such as, for example, Java, Ruby, Ruby on Rails, Lua, C, C#, and/or C++. These may be compiled and linked into an executable program, installed in a dynamic link library, or may be written in an interpreted programming language such as, for example, BASIC, Perl, or Python. It will be appreciated that these modules may be callable from others and/or from themselves, and/or may be invoked in response to detected events or interrupts. In an embodiment, these modules are stored in the storage device 208 and loaded into the memory 206 for execution by the processor 202. The modules described herein in certain applications are implemented as software modules, but may be represented in hardware or firmware in other implementations. Generally, the modules described herein refer to logical modules that may be combined with other modules and/or divided into sub-modules despite their physical organization or storage.

As shown in FIG. 3, the print stream augmentation device 104 includes a print stream parser module 310 that allows the print stream augmentation device 104 to parse print streams received via a communications module 316. In an embodiment, a print stream parser module 310 uses a configured set of regular expressions to parse the print data stream and extract selected pieces of information from the stream. As is known in the art, regular expressions are a method of expressing a set of patterns to be matched and a set of data within those matched patterns to be extracted from the patterns. For example, in an embodiment, the print stream parser module 310 uses a set of regular expressions configured to recognize and extract from a print data stream representing a printed check and comprising a set of data elements including, but not limited to, the date and time printed as part of the check, the point-of-sale terminal from which the check was printed, the department for which the check was printed, the identity of the staff member responsible for the check's transaction, the table number or guest number for which the check is printed, the check number of the check, the transaction identifier of the transaction for which the check is printed, the item descriptions printed within the check, the item quantities printed within the check, the item charges printed within the check, the subtotal printed within the check, the tax charge lines printed within the check, and the total charge printed within the check. Other transaction data elements are possible based on the type of retail/service environment in which the point-of-sale system is deployed. Although a check (e.g., a check with information related to an amount owed) is used as an example above, in other embodiments, the print stream parser module is similarly configured to extract these data elements from a print data stream for any type of paper/document with transaction information, such as a printed receipt (e.g., a receipt for a purchase) or ticket (e.g., concert, sporting event, transportation ticket, etc.).

In an embodiment, the print stream augmentation device 104 includes a graphical code generator module 312 configured to generate a graphical code. The graphical code may be a 1D barcode, a 2D barcode, or other type of barcode/image suited for embedding information that can be optically scanned and interpreted. When the graphical code module 312 is configured to generate a 1D barcode, the 1D barcode may be generated using any 1D barcode symbology such as EAN 13, GS1 DataBar, GS1-128 or other 1D barcode symbology. When the graphical code module 312 is configured to generate a 2D barcode, the 2D barcode may be generated using any 2D code symbology such as QR code, Datamatrix, High Capacity Color Barcode, ShotCode, SPARQCode or other 2D code symbology. In an embodiment, 2D code generator module 312 is configured to generate a QR code. The generated image/barcode (whether it be QR code or other type of code) may include some or all of received transaction data within the print data received print stream. In addition, as previously described above, the print stream augmentation device 104 may receive additional data (e.g., from a remote server) and the additional data may be encoded in the image/barcode along with some or all of the received transaction data. The following paragraph provides one example set of data that is embedded in a QR code according to an embodiment.

In an embodiment, the generated QR code contains a Uniform Resource Identifier (URI). In an embodiment, the contained URI uses a scheme component such as “https”, a host address component such as “www.rewardloop.com”, a path component such as “/scan”, and a query component such as “?t=00X” where X is replaced with a transaction descriptor string TRANSACTION_DESCRIPTOR. In an embodiment, the transaction descriptor string is formed as follows.

Given the following values:

TERMINAL_ID is the identity string of the print stream augmentation device 104 stored by configuration storage module 334.

ISO_TIME is the ISO 8601 representation of the date and time at which the challenge value is generated. Example: “2011-05-20T22:23Z”

RECEIPT_NUMBER is the receipt number included by the point-of-sale system in the print data stream and extracted by an extractor regular expression rule.

POS_TRANSACTION_ID is the POS system's transaction ID included by the point-of-sale system in the print data stream and extracted by an extractor regular expression rule.

SUBTOTAL is the subtotal for the transaction, included by the point-of-sale system in the print data stream and extracted by an extractor regular expression rule.

DELIMITER is a string delimiter, taken to be the pipe symbol “|”

Then the transaction descriptor value is calculated as follows:

TRANSACTION_DESCRIPTOR=CONCATENATE(TERMINAL_ID,DELIMITER,ISO_TIME,DELIMITER,RECEIPT_NUMBER,DELIMITER,POS_TRANSACTION_ID,DELIMITER,SUBTOTAL)

The print stream augmentation device 104 in an embodiment includes a print stream injector module 330 configured to add additional data to the buffered print stream when triggered to do so by the print stream parser module 310. In an embodiment, the additional data includes one or more of: (1) an encoded representation of a call to action directing a customer receiving the check to use their mobile phone to scan a 2D barcode printed on the check to enroll in the merchant's loyalty program or to earn loyalty rewards or prizes if already enrolled, (2) an encoded representation of a 2D barcode, and (3) an encoded representation of instructions directing the customer receiving the check to download a 2D barcode scanner for their mobile phone if they do not already have a 2D barcode scanner. In another embodiment, the additional data includes an encoded representation of a logo and branding element composed with the 2D barcode.

The print stream augmentation device 104 includes a printer language encoding module 314 configured to encode content data into the format defined by a particular printer language. The content data for encoding may be text data or may be image data. In an embodiment, the printer language encoding module 314 is configured to encode content data into the Epson ESC/POS printer language format.

Many Epson-compatible printers supporting the ESC/POS printer language present particularly problematic issues in the implementation of 2D barcode printing such QR code printing. The problems include (1) variations in the available commands for encoding graphical output for printing, some variations being unsupported by certain models of Epson-compatible printers, (2) undocumented deficiencies in the output by some Epson-compatible printers of graphical data encoded in the ESC/POS printer language, (3) unacceptably slow print speeds when using certain enhanced-resolution features of Epson-compatible printers.

To overcome such issues, in an embodiment, the print stream language encoding module 314 is configured to encode graphical content using the ESC/POS printer language with one or more of the following commands. For example, the print stream language encoding module 314 may be further configured to use the “GS v 0” (hexadecimal representation 0x1D 0x76 0x30) ESC/POS command, rather than other available commands including “GS Q 0” (hexadecimal representation 0x1D 0x51 0x30), “G(L” (hexadecimal representation 0x1D 0x28 0x4C), and “GS 8 L” (hexadecimal representation 0x1D 0x38 0x30) in order to maximize compatibility with the installed base of Epson-compatible printers. Avoidance of the “GS Q 0” command aids compatibility—for instance Epson models including the TM-T88IV released in 2006 and TM-T90, TM-T70, TM-L90, TM-P60, TM-U230, TM-U220, and presumably models released after 2006 do not support the “GS Q 0” command. The print stream language encoding module 314 may be further configured to avoid of the “G(L” and “GS 8 L” commands as avoidance of these commands aids compatibility—for instance the TM-T88III released in 2001 does not support these commands. In this embodiment, the print stream language encoding module 314 is further configured to encode the QR code graphical content such that the smallest features of the QR code (referred to as “modules” in ISO/IEC 18004:2000 and referred to here as “QR code block modules” for clarity) are represented as a 4×4 printed dot pattern. This graphical representation avoids undocumented deficiencies in many Epson-compatible ESC/POS printers that seriously corrupt the printed output when printing QR code block modules using smaller dot patterns of 3×3, 2×2, or 1×1 printed dots. In this embodiment, print stream language encoding module 314 is further configured to use “mode 3” of the “GS v 0” command, rather than “mode 0”, “mode 1” or “mode 2”. “Mode 3” is also known as “Quadruple” mode in reference to the fact that it quadruples the size of graphics printed at the expense of also reducing the resolution of graphics printed by 4 times. “Mode 0” also known as “Normal” mode and offering the highest output resolution, may seem desirable as a way to optimize the graphical output of the QR code in the presence of the previously mentioned deficiencies, but this mode imposes a serious print speed penalty both due to slower print head speed and slower data transfer speed over the low data rate RS-232 communication port commonly included in Epson-compatible printers. This embodiment demonstrates the novel capability of the invention to reliably print 2D codes via the broad installed base of currently deployed ESC/POS-compatible printers.

The print stream augmentation device 104 in an embodiment optionally includes an NFC pad interface module 336 configured to deliver commands to an optional near field communications pad 108. In an embodiment the commands delivered instruct the near field communications pad 108 to emulate a passive NFC tag containing a URI. In an embodiment, the NFC tag is configured to present the URI record as described in the NFC Forum URI Record Type Definition Technical Specification. The URI is constructed by the NFC pad interface module 336 in the same manner as described in the URI construction performed by the graphical code module 312 for embedding in a graphical code.

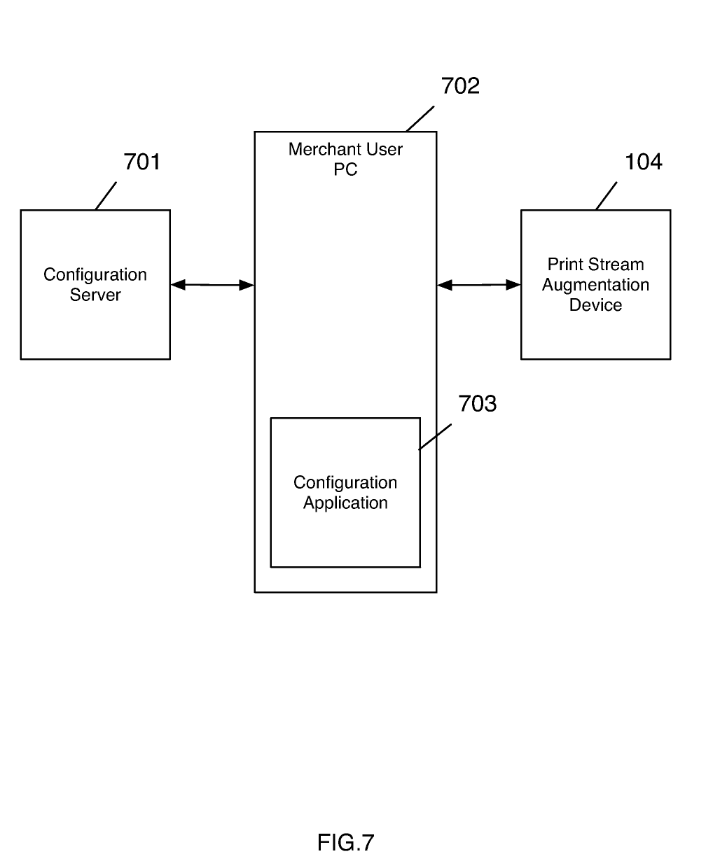

As shown in FIG. 7, in an embodiment the print stream augmentation device 104 may be attached to a merchant PC 702 via a USB port or other port technology. Merchant PC 702 has a configuration application 703 installed that is downloaded from the support page for the print stream augmentation device 104.

When executed, the configuration application 703 prompts the merchant user to plug their print stream augmentation device into their merchant PC 702 via, for instance, the USB port. Then the configuration application 703 prompts the merchant user authenticate with their merchant user credentials. The configuration application then verifies the authentication with configuration server 701 via the merchant PC's 702 Internet connection. Upon successful authentication, configuration application 703 downloads from configuration server 701 the latest firmware image for the print stream augmentation device 104 and/or the regular expression and associated injection rule configuration for the device.

### III. PROCESS/EXAMPLE

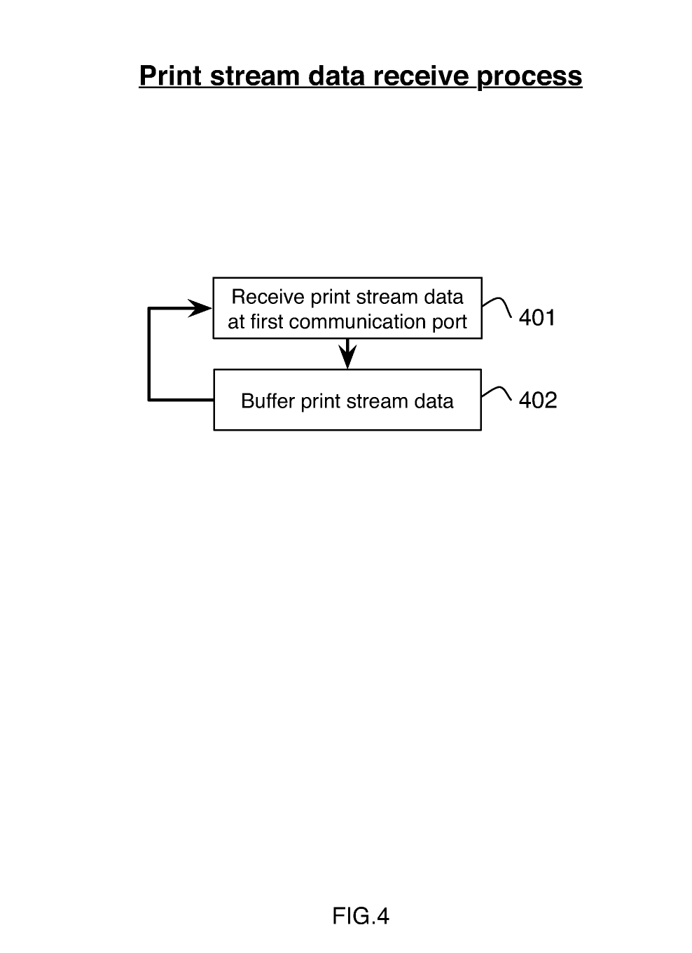

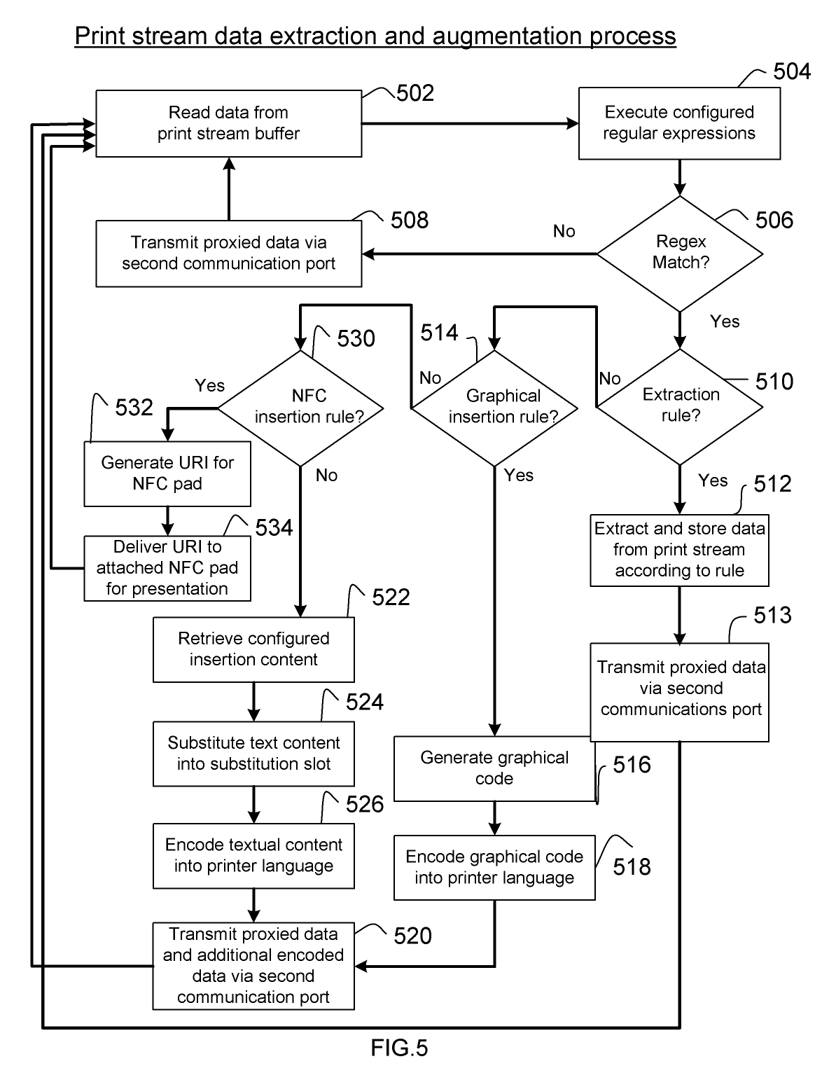

FIG. 4 and FIG. 5 are flow charts illustrating the operation of the print stream augmentation device 104 according to an embodiment. Those of skill in the art will recognize that other embodiments can perform the steps of FIG. 4 and FIG. 5 in different orders. Moreover, other embodiments can include different and/or additional steps than the ones described here.

FIG. 4 and FIG. 5 illustrate steps performed by the print stream augmentation device 104 in an example print job where the point-of-sale system 102 is transmitting print stream data that is received at the print stream augmentation device 104 via the communications port 210.

In block 410, the print data stream received by communication port 210 is presented to communications module 316, and in block 402 communications module 316 buffers the received data in the received print data buffer 318. In an embodiment, the process depicted in FIG. 4 is performed by one thread of execution, which may be implemented as a thread, a green thread, a kernel process or other thread of execution mechanism, while the process depicted in FIG. 5 is performed by another thread of execution. However, in other embodiments both processes can be handled by a common thread of execution.

Referring to FIG. 5, at block 502, the print stream parser module 310 reads print data from the received print data buffer 318. In an embodiment, the print stream parser module 310 then executes at block 504 the configured regular expressions against the data read from the received print data buffer. The print stream parser, after execution of a regular expression, determines at block 506 whether the regular expression resulted in a match. If a regular expression has not matched for the read data, then the read data is transmitted at block 508 via the second communications port 212 (to the peripheral device 106). This case results in no additional data being injected into the print stream data for the currently received data in the print data buffer.

In an embodiment, the print stream parser module 310 may execute one or both of the following two types of regular expressions against the data. First, those regular expressions that are configured to capture and extract a portion of the print data stream which is referred herein as “extractor rules.” Second, those regular expressions that are configured to recognize a point within the print data stream at which additional data is to be injected into the print data stream, which is referred herein as “injector rules.”

If a regular expression has matched for the read data, then the print stream parser module 310 determines at block 510 whether the match is associated with a configured extraction rule or a configured insertion rule.

If the match is associated with a configured extraction rule, then the print stream parser module 310 at block 512 extracts and stores the extracted data according to the extraction rule, for later use. For example, the print stream parser module 310 may be configured with extractor rules to capture the check number and the total charge from print data representing a check. At block 513, the print stream data parser then transmits the read data via the second communications port to the peripheral device 106. The extracted data may later be used to generate the data for barcode (e.g., QR code) and/or NFC as further described below.

If the match is not associated with a configured extraction rule, then the print stream parser module 310 checks at block 514 whether the insertion rule is a graphical insertion rule or a non-graphical insertion rule.

Assume for this example that the print stream parser module 310 has been configured with a single graphical injector rule that is configured to inject a QR code image into the print data stream after the total charge line via configured insertion content that contains a marker for QR code content injection, and has been configured with a single non-graphical injector rule that is configured to inject a web address and call to action.

In an embodiment, when the graphical injector rule is triggered, the print stream parser module 310 notifies the print stream injector module 330 that the configured graphical injector rule name “QRCODE-INJECT” has been triggered. The print stream injector module 330 then requests the QR code generator module 312 to generate a QR code for insertion into the print data stream at block 516. In another embodiment, the print stream injector module 330 requests from the QR code generator module 312 a QR code that has already been generated and stored by the QR code generator module prior to the current request. In another embodiment, the print stream injector module 330 retrieves a static QR code that was pre-generated and loaded onto the print stream augmentation device 104 during configuration at the factory or in the field. In other embodiments, the print stream injector module 330 generates and injects code for printing other types of graphical representation such as a 1D barcode.

The print stream injector module 330, having requested and retrieved a QR code image, requests from the print stream language encoding module 314 to encode the graphical code image data for use by a printer at block 518. The print stream language encoding module 314 then encodes the image provided by the print stream injector module 330 into encoded data, such as in the ESC/POS printer language.

At block 520, the print stream injector module 330, having requested and retrieved the print stream encoded representation of the image, requests the communication module 316 to transmit the proxied read data and the encoded image data (e.g., for a QR code) via the second communications port 212 to the peripheral device 106.

The print stream injector module 330, having completed the injection process for the triggered injection rule, then returns control to the print stream data parser module 310.

The print stream parser module 310, elsewhere in the print data stream, may encounter a match for the regular expression configured which, when checked at block 514, is not associated with a graphical insertion rule. The print stream parser module 310 then checks at block 530 whether the match is associated with an NFC insertion rule or a non-NFC insertion rule. In an embodiment, when the non-NFC injector rule is triggered, the print stream parser module 310 notifies the print stream injector module 330 that the configured non-NFC injector rule has been triggered, which covers the case when textual information is to be inserted. At block 522, the print stream injection module 330 then retrieves the configured non-NFC insertion content for the injector rule. In an embodiment, the non-NFC insertion content may contain named markers which denote locations within the content at which stored data should be substituted into the content. The print stream injection module 330 then substitutes, at block 524, the appropriate data for each named marker in the content. The print stream injection module 330 then requests the print stream language encoding module 314 at block 526 to encode the textual content into the appropriate format for delivery to the printer. The print stream injector module 330 then requests the communication module 316 to transmit 520 the proxied read data and the added data for the textual content via the second communications port 212.

If the regular expression match upon checking at block 530 is associated with an NFC insertion rule, the print stream parser module 310 notifies the print stream injector module 330 that the configured NFC injector rule has been triggered.

Assume for this example that the print stream parser module 310 has been configured with a single NFC injector rule that is configured to deliver a URI for presentation by the NFC pad as a passive target when the “BALANCE DUE” line is encountered in the print data stream.

In an embodiment, when the NFC injector rule is triggered, the print stream parser module 310 notifies the NFC pad interface module 336 that the configured NFC injector rule name “NFC-INJECT” has been triggered. At block 532, the NFC pad interface module 336 generates a URI for presentation by the attached near field communications pad 108. In another embodiment, the NFC pad interface module 336 retrieves from configuration storage module 334 a URI that has already been generated and stored by the NFC pad interface module 336 prior to the current request. In another embodiment, the NFC pad interface module 336 retrieves a static URI that was pre-generated and loaded onto the print stream augmentation device 104 during configuration at the factory or in the field. In an embodiment, the NFC pad interface module 336 then at block 534 delivers the URI to the attached near field communications pad 108 via the third communications port 214 for presentation as an emulated NFC passive target.

After the URI is delivered to the near field communications pad 108, the URI will be presented as an emulated NFC passive target to an NFC reader that is placed in very close proximity to the near field communications pad 108. In an embodiment, the NFC reader functionality is integrated into a customer mobile device 112, and upon placing customer mobile device 112 in close proximity to near field communications pad 108, the URI is acquired and a default action is performed by the NFC reader functionality of the customer mobile device 112. Typically this default action for a URI is to open the URI in a web browser. In an embodiment, the URI directs the customer's web browser to a transaction processing page within a web based loyalty application.

The example above is a sample processing flow, and various embodiments may be configured in other ways to exploit variant flows. For example, any number of extraction rules may be defined, and any number of graphical and non-graphical injection rules may be defined. Data extracted via extraction rules may be used for injection later in the print stream as part of the same or later print jobs.

As described, a notable feature of some embodiments includes support for Near Field Communications (NFC). In an embodiment the print stream augmentation device 104 supports another injection rule type in addition to graphical and non-graphical injection rules, an NFC insertion rule, and the print stream augmentation device 104 includes a connection to an NFC pad. The NFC pad may be attached to a communication port supporting USB, or via another communication port type. This rule operates similarly to a graphical insertion rule configured to generate a QR code with a uniform resource locator (URL) or URI as specified in embodiments described in this disclosure, with the following key difference. When an NFC injection rule is triggered, the print stream augmentation device presents the URL or URI to the near field communications device 108 via an NFC device driver, such that the near field communications pad 108 will present the URL or URI in a passive target mode, also known as an NFC tag emulation mode. When presented in this manner, the URL or URI may be read by a customer mobile device 112 with standard NFC reader capability. In this way it can be seen that embodiments disclosed herein support the use of NFC technology to present information to a second NFC reader device, and that the information presented may include information collected from the print data stream, and that the presentation of said information may be triggered by the regular expression mechanism.

### IV. PROCESS/EXAMPLE

### Alternative Embodiments—Secure Redemption

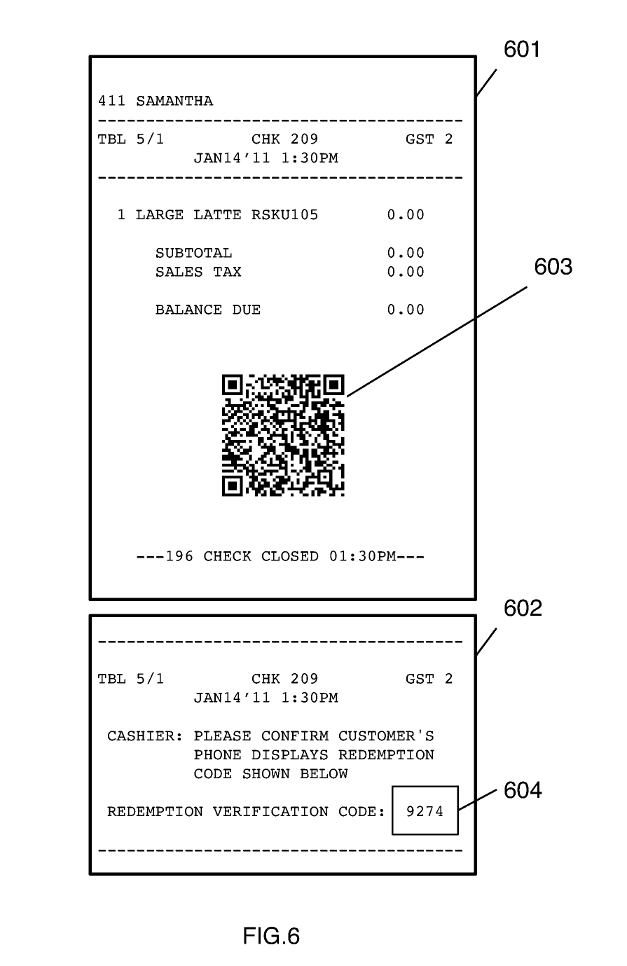

The process illustrated in FIG. 5 can also be adapted for a secure redemption purpose. FIG. 6 illustrates an exemplary redemption receipt 601 with a QR code 603, and a redemption verification slip 602. The redemption verification slip 602 includes the redemption verification code 604, the redemption verification code 604 having been inserted into the configured redemption slip content string.

FIG. 6. illustrates an example in which the point-of-sale system 102 includes within the print data stream representing the redemption receipt 601, an item that has been entered into the point-of-sale system by the retail staff as an item being purchased in whole or in part by the customer using stored loyalty value the customer possesses, or using a payment method the customer possesses. Such payment method may be a stored credit card, debit card, bank card, prepaid card, gift card, or a mobile wallet application with access to these or other payment methods.

In an embodiment, the item is then represented in the redemption receipt 601 with a redemption SKU (RSKU) included in the item description line, as shown in FIG. 6. In another embodiment, the item is represented in the redemption receipt without an RSKU but only with an item text description unique to the item.

In an embodiment, the print data stream parser module 310 is configured with extractor rules to capture RSKU numbers appearing/encoded in the print data stream. Furthermore, the print stream parser module 310 is in embodiment configured with one graphical injector rule and one non-graphical injector rule. The first injector rule is configured to inject a QR code image into the print data stream after the “BALANCE DUE” line and is configured with injector rule name “QRCODE-INJECT”. The second injector rule is configured to inject a redemption slip encoding into the print data stream after the “CHECK CLOSED” line ending the receipt representation generated by the point-of-sale system, and is configured with injector rule name “REDEMPTION-SLIP-INJECT”.

In an embodiment, when the QRCODE-INJECT pattern triggers the QRCODE-INJECT injector rule, the print stream parser module 310 notifies the print stream injector module 330 that the injector rule named “QRCODE-INJECT” has been triggered. In an embodiment, the print stream injector module 330 then requests the graphical code generator module 312 to generate a graphical redemption code for insertion into the print data stream. In another embodiment, the print stream injector module 330 requests from the graphical code generator module 312 a graphical redemption code that has already been generated and stored by the graphical code generator module 312.

In an embodiment, the graphical code generator module 312 is configured to generate a redemption QR code 603 as the graphical redemption code. In an embodiment, the generated redemption QR code contains a URL or Uniform Resource Identifier (URI). In an embodiment, the contained URI uses a scheme component such as “https”, a host address component such as “www.rewardloop.com”, a path component such as “/scan”, and a query component such as “?t=01Y”, where Y is replaced with a redemption challenge value REDEMPTION_CHALLENGE.

The redemption challenge value and the valid redemption response value are formed by the following process, which is referred to as the “redemption response value process.” Given the following values:

KEY is the pre-shared secret key stored by configuration storage module 334.

TERMINAL_ID is the identity string of the print stream augmentation device 104 stored by configuration storage module 334.

ISO_TIME is the ISO 8601 representation of the date and time at which the challenge value is generated. Example: “2011-05-20T22:23Z”

RECEIPT_NUMBER is the receipt number included by the point-of-sale system in the print data stream.

RSKU is the RSKU number of the item which is being processed for redemption

DELIMITER is a string delimiter, taken to be the pipe symbol “|”

Then the redemption challenge value is calculated as follows:

REDEMPTION_CHALLENGE=CONCATENATE(TERMINAL_ID,DELIMITER,ISO_TIME,DELIMITER,RECEIPT_NUMBER,DELIMITER,RSKU)

And the valid redemption response value is calculated as follows:

VALUE1=HMAC(KEY,REDEMPTION_CHALLENGE)

VALUE2=BASE_{—}10(VALUE2)

VALID REDEMPTION RESPONSE=FIRST_{—}4_CHARACTERS(VALUE2)

Where for the purposes of the example presented, the function HMAC is calculated as defined in IETF RFC 2104 (http://tools.ietf.org/html/rfc2104), and the hash function H is taken to be the SHA2-256 secure hash function as defined in Federal Information Processing Standard Publication 180-2 published by the National Institute of Standards and Technology. In other embodiments that calculation of the redemption response value may be different in the use, or not, of a message authentication code such as HMAC or other message authentication code, and may be different via the use of a different secure hash function. CONCATENATE is a simple string concatenation function. BASE_{—}10 is a function defined to convert its input value into a base-ten numeric representation. FIRST_{—}4_CHARACTERS is a function defined to return the first four characters of its input value.

After performing the calculation above, the resulting expected challenge response value is a string of digits of length 4.

When the REDEMPTION-SLIP-INJECT pattern triggers the REDEMPTION-SLIP-INJECT injector rule, the print stream parser module 310 notifies the print stream injector module 330 that the injector rule named “REDEMPTION-SLIP-INJECT” has been triggered. The print stream injector module 330 then injects the redemption slip representation, including a partial cut command to separate the redemption slip paper from the receipt paper, and including redemption slip content with content inserted at configured points in the configured redemption slip content string. In an embodiment, content insertions are configured for the expected challenge response value. The print stream injector module 330 requests the communications module 316 to transmit the print stream encoded representation of the redemption slip via the second communications port 212.

A variant of this alternative embodiment includes support for presentation of the redemption verification code via a cashier display rather than via printing of a redemption slip 602. This has the benefit of avoiding the possibility of a customer surreptitiously and skillfully reading the value on the redemption verification slip 602 as it prints. Such a cashier display may be connected to the print stream augmentation device via a standard USB port for example, or other port technology.

### V. ALTERNATIVE EMBODIMENTS

### Secure Location Check-in

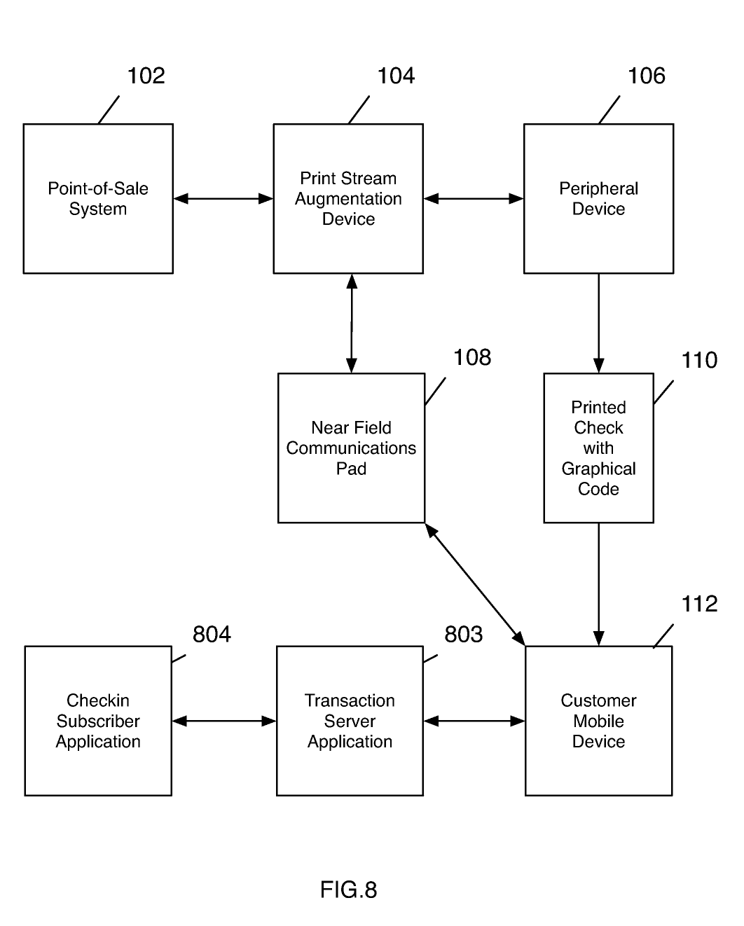

FIG. 8 is a block diagram illustrating a computing environment according to alternative embodiments related to location check-in. The point of sale system 102, peripheral device 106, the near field communications pad 108, and the print stream augmentation device 104 have similar functions as previously described above. Additionally, the customer mobile device 112 is a mobile device with Internet connection capability.

In an embodiment, the customer mobile device 112 also has a camera and a QR code reader application (or similar barcode reading application for reading barcode) which may be either a generic QR code reader or a specialized loyalty, payment, or check-in application including QR code scanning capability as part of its functionality. Transaction server application 803, in an embodiment, is an application executed on a server that performs a primary transaction processing action when presented with a transaction request by the customer mobile device 112.

In an embodiment the transaction server supports one or both of the two transaction request types described in earlier embodiments (e.g., loyalty earning transactions and loyalty redemption transactions). In other embodiments transaction server application 803 may support other types of transaction requests implemented via printed, displayed, or NFC passive target delivered transaction content output by the print stream augmentation device 104.

In addition to the primary transaction processing function, the transaction server application 803 performs notifications to one or more check-in subscriber applications 804 that have registered to receive such notifications. In an embodiment, the check-in subscriber application 804 is a server that is configured to receive notification of transaction requests made by the customer mobile devices 112.

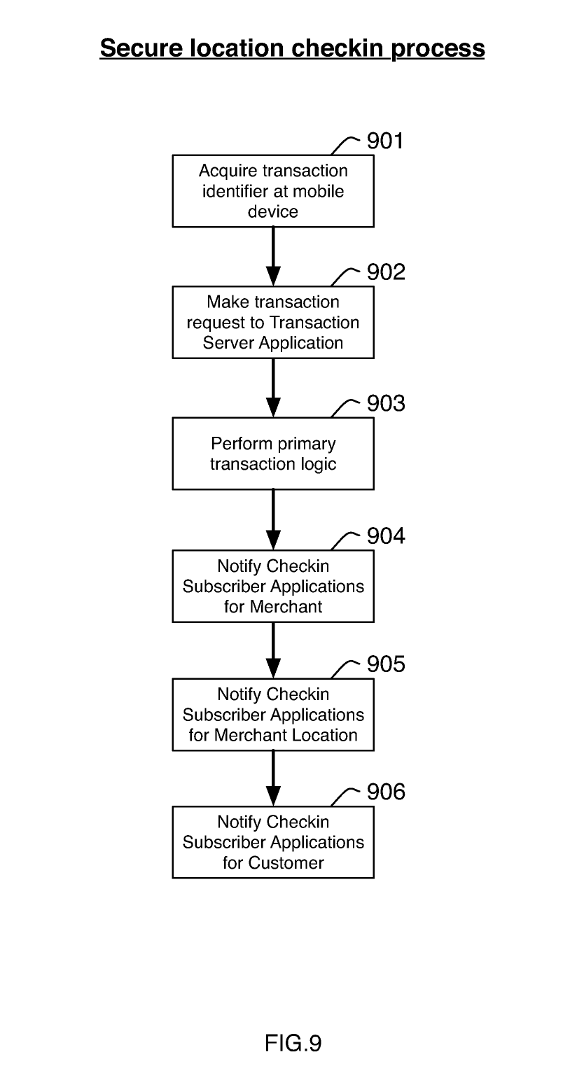

FIG. 9 is a flow chart illustrating the operation of the computing environment of FIG. 8 according to the secure location check-in alternative embodiment. Those of skill in the art will recognize that other embodiments can perform the steps of FIG. 9 in different orders. Moreover, other embodiments can include different and/or additional steps than the ones described here.

FIG. 9 illustrates steps performed by the print stream augmentation device 104 in an exemplary secure location check-in process. Assume for the purposes of example that the print stream augmentation device operates as described previously in the embodiments illustrated in FIGS. 1-5 or the secure redemption flow alternative embodiments.

In an embodiment, a customer makes use of the customer mobile device 112 to optically scan the printed check 110, acquiring at block 901 the transaction identifier that is embedded in the scanned QR code. In another embodiment, a customer makes use of the customer mobile device 112 to perform a near field communications “tap” against the near field communications pad 108, acquiring at block 901 the transaction identifier presented by the near field communications pad 108 as a passive target. In this example the transaction identifier is presented as a URI with parameters. The transaction identifier may be encoded in a number of different formats, provided that the transaction identifier provides enough information to uniquely resolve the transaction.

At block 902, the customer mobile device 112 then makes a request to the transaction server application 803 to process the transaction. The transaction server application then processes the transaction by performing the primary transaction logic at block 903. The primary transaction logic may be related to a loyalty earning transaction, loyalty redemption transaction, payment transaction, transaction of other types, or a combination thereof.

In an embodiment, the transaction server application 803 then performs a lookup to retrieve a list of check-in subscriber applications 804 that have requested notification of transactions occurring at point-of-sale systems 102 operated by the merchant associated with the transaction request. At block 904, the transaction server application 803 then notifies each check-in subscriber application 804 on the list.

In an embodiment, the transaction server application 803 may also perform a lookup to retrieve a list of check-in subscriber applications 804 that have requested notification of transactions occurring at the merchant location associated with point-of-sale system 102. At block 905, the transaction server application 803 then notifies each check-in subscriber application 804 on the list.

In an embodiment, the transaction server application 803 may also perform a lookup to retrieve a list of check-in subscriber applications 804 that have requested notification of transaction requests made by the customer authenticated at the customer mobile device 112. At block 906, the transaction server application 803 then notifies each check-in subscriber application 804 on the list.

In an embodiment, the notifications provided to the check-in subscriber applications 804 contain the identity of the customer that participated in the transaction, as an email address, Facebook id, other social id, open id, database primary key, mobile device id/IP address, mobile phone number, or other user identifier; the identity of the merchant; the location at which the transaction occurred; a list of UPCs of items associated with the transaction, if applicable; the price of each item associated with the transaction; a list of promotional coupons applied to the transaction; the value of the transaction; the time of the transaction; the payment method used to pay for the transaction; and the payment method account used to pay for the transaction. Other embodiments may provide only a subset of these contents, and may filter the provided contents based on permissions associated with the check-in subscriber application 804 accessible to the transaction server application 803.

These location check-in related embodiments support a system of notifications of location and social check-ins to interested subscriber applications, including third party subscriber applications operated by a different party than the print stream augmentation device or transaction servers themselves. These notifications may be used to provide automatic check-ins to social networks such as Facebook®, Foursquare®, Twitter®, Gowalla® and many other similar networks.

The above described location check-in related embodiments have a wide variety of practical applications. For example, given a collection of notifications from various merchants participating in such a system, a check-in subscriber application 804 could be configured to implement a crowd-sourced “lowest price finder” application. Purchases of items identified by the item's UPC code could be monitored for the lowest price in a given geographic area and distributed to consumers via a mobile application or mobile website.

### V. CONCLUSION

While certain embodiments of the inventions have been described, these embodiments have been presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, those skilled in the art will appreciate that in various embodiments, the actual steps taken in the processes shown in FIGS. 4, 5, and 9 may differ from those shown in the figures. Depending on the embodiment, certain steps described in the example above may be removed, others may be added, and the sequence of steps may be altered and/or performed in parallel.

Other variations from the above describe embodiments are also possible. For example, although this disclosure describes examples in which QR barcodes and 2D barcodes are used, those skilled in the art will recognize that the various embodiments disclosed are applicable to systems with other barcoding and/or graphical representation system in which data is embedded into graphical data. In addition, the functionalities of the print stream argumentation device may be implemented in software and/or firmware such that a point-of-sale system integrated with a peripheral receipt printer may augment the print stream as described above. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A device for augmenting a print data stream sent from a point-of-sale terminal to a printer, the device comprising:
a input port for receiving the print data stream from the point-of sale terminal, said print data stream representing a transaction record for a transaction conducted by a customer;
a buffer configured to store the print data stream;
a processor configured to augment the buffered print data stream by extracting transaction data from the print data stream, and by adding to the print data stream a representation of an encoded image, said coded image having the transaction data encoded therein, and being capable of being read and decoded by a mobile device of the customer; and
an output port for sending the augmented print data stream to the printer to cause the printer to print a modified transaction record that includes the encoded image.

2. The device of claim 1, wherein the processor is configured to encode the transaction data in a uniform resource identifier, and to encode the uniform resource identifier in the encoded image.

3. The device of claim 2, wherein the uniform resource identifier is associated with a loyalty program system that is configured to use the transaction information to credit a loyalty program account of the customer.

4. A system for augmenting print data stream of a point-of-sale system, comprising:
a computing system in communication with the point-of-sale system, the computing system configured to implement:
a receiving module configured to receive a print data stream with transaction data from the point-of-sale system;
an extraction module configured to extract at least a portion of the transaction data from the received print data stream; and
a generation module configured to generate data based at least in part on the extracted transaction data, the generated data being adapted to cause a generation of an optically scannable image; and
an insertion module configured to insert the generated data into at least a portion of the received transaction data to create output data that includes the optically scannable image.

5. The system of claim 4, wherein the generated data comprises a transaction identifier.

6. The system of claim 4, wherein the insertion module is further configured to insert the generated data into the at least a portion of the received transaction data at a location within the portion that is determined by a matching rule.

7. The system of claim 4, further comprising a communications port configured to transmit the output data to a printing device adapted to print the generated data to paper.

8. The system of claim 4, further comprising a communications port configured to transmit the output data to a display device adapted to display the generated data.

9. The system of claim 4, further comprising a communications port configured to transmit the output data to a near field communication (NFC) pad that is configured to present a uniform resource identifier (URI) to an NFC reader in response to receipt of the output data.

10. The system of claim 4, wherein the generated data encodes a stored value earning event.

11. The system of claim 4, wherein the generated data encodes a redemption request.

12. The system of claim 4, wherein the generated data includes a two-dimensional barcode image.

13. The system of claim 4, wherein the output data is in a printer language command set.

14. The system of claim 13, wherein the optically scannable image includes a two-dimensional barcode, and at least some of features of the two-dimensional barcode are encoded in a printer language command set.

15. A device for augmenting a data stream sent from a point-of-sale terminal to a peripheral device, the device comprising:
an input port for receiving the data stream from the point-of sale terminal, said data stream representing a transaction record for a transaction conducted by a customer;
a buffer configured to store the data stream;
a processor configured to augment the buffered data stream by extracting transaction data from the data stream, and by adding to the data stream a representation of an encoded image, said coded image having the transaction data encoded therein, and being capable of being read and decoded by a mobile device of the customer; and
an output port for sending the augmented data stream to the peripheral device to cause the peripheral device to output a modified transaction record that includes the encoded image.

16. The device of claim 15, wherein the processor is configured to encode the transaction data in a uniform resource identifier, and to encode the uniform resource identifier in the encoded image.

17. The device of claim 16, wherein the uniform resource identifier is associated with a loyalty program system that is configured to uses the transaction information to credit a loyalty program account of a customer.

18. A method for processing print data stream related to a point-of-sale system, comprising:
receiving a print data stream with transaction data;
extracting at least a portion of the transaction data from the received print data stream; and
generating data based at least in part on the extracted transaction data, the generated data being adapted to cause a near field communication (NFC) device to communicate data related to the transaction to another device; and
outputting the generated data to the NFC device,
wherein the method is performed in its entirely by a computing system comprising one or more computing devices.

19. The method of claim 18, wherein the generated data encodes a transaction identifier.

20. The method of claim 18, wherein the generated data encodes a stored value earning event.

21. The method of claim 18, wherein the generated data encodes a redemption request.

22. The method of claim 18, wherein the NFC device is a NFC pad that is configured present a uniform resource locator (URL) to an NFC reader in response to receipt of the output data.

23. A method for transferring transaction data, comprising:
receiving a data stream with transaction data from a first system;
extracting, with a processor, at least a portion of the transaction data from the received data stream; and
formatting the extracted transaction data to enable communication of the extracted data to a device; and
outputting the generated data to the device.

24. The method of claim 23, wherein the generated data encodes a transaction identifier.

25. The method of claim 23, wherein the device is a near field communication (NFC) pad.

26. The method of claim 23, wherein the device is a printer.

27. The method of claim 26, wherein the extracted data is output to the printer as a two-dimensional bar code.

28. The method of claim 26, wherein the two-dimensional bar code includes an encoded uniform resource identifier (URI).

29. The method of claim 23, wherein extracting at least a portion of the transaction data includes matching a pattern in the data stream.

30. A method for delivering customer transactions to subscribing applications, comprising:
acquiring a transaction identifier for a transaction at a first device;
communicating the transaction identifier from the first device to a server over a network;
performing a lookup to retrieve a list of subscriber applications associated with the transaction identifier; and
notifying each subscriber application on the list.

31. The method of any one of claim 30, comprising: providing the subscriber application with the identity of a customer that participated in the transaction.

32. The method of claim 30, wherein the transaction identifier includes a check-in.

33. The method of claim 30, wherein the transaction identifier includes a loyalty earning transaction.

34. The method of claim 30, wherein the transaction identifier includes a loyalty redemption transaction.

35. The method of claim 30, wherein the transaction identifier includes a payment transaction.

36. The method of claim 30, wherein the first device is a mobile device that includes a camera.

37. The method of claim 30, wherein the first device is a mobile device that includes a near field communication (NFC) interface.

38. A method of verifying a loyalty redemption transaction, comprising:
encoding a stored value redemption request with a generation module in a augmentation device coupled to a point of sale system;
cryptographically signing the request at the augmentation device;
generating a graphical code that includes the signed request;
calculating an expected redemption validation code at the augmentation device;
transmitting the expected redemption validation code to a peripheral device associated with the point of sale system;
presenting the graphical code to a user device;
receiving the request at a server from the user device;
verifying at the server that a sufficient stored value is present in a stored value account associated with the user device;
calculating, at the server, the expected redemption validation code; and
transmitting the expected redemption validation code to the user device.

39. At least one computer readable medium comprising a plurality of instructions that in response to being executed on one or more computing devices can cause the computing devices to perform a method comprising:
encoding a stored value redemption request with a generation module in a augmentation device coupled to a point of sale system;
cryptographically signing the request at the augmentation device;
generating a graphical code that includes the signed request;
calculating an expected redemption validation code at the augmentation device;
transmitting the expected redemption validation code to a peripheral device associated with the point of sale system;
presenting the graphical code to a user device;
receiving the request at a server from the user device;
verifying at the server that a sufficient stored value is present in a stored value account associated with the user device;
calculating, at the server, the expected redemption validation code; and
transmitting the expected redemption validation code to the user device.
